(19) United States
(12) Patent Application Publication
(10) Pub. No.: US 2002/0178363 A1
(43) Pub. Date: Nov. 28, 2002

(54) System and method for authentication of items

(76) Inventors: F. Carl Ambrogio, Greenwich, CT (US); Paolo Ferrari, Cos Cob, CT (US)

Correspondence Address: PERMAN & GREEN, 425 POST ROAD, FAIRFIELD, CT, 06824, US

(21) Appl. No.: 10/117,265

(22) Filed: Apr. 5, 2002

Related U.S. Application Data
(60) Provisional application No. 60/283,406, filed on Apr. 13, 2001.

(51) Int. Cl. H04L 9/00

(52) U.S. Cl. 713/176

(57) ABSTRACT

A system and method for authentication of an item, comprising a substantially invisible watermark secured to the item for uniquely identifying the item, wherein the watermark is nonremovable and includes a substantially invisible authentication code for identifying the item. A unique identification code is associated with the item, wherein the identification code differs from the authentication code. A storage area includes owner identification information for linking the item to an owner, wherein the identification code is linked to the authentication code of the item and to the owner identification information. Entry of data which matches the linked owner identification information, the authentication code and the identification code in the storage area authenticates the ownership and certifies the authenticity of the item.

### CROSS REFERENCES TO RELATED APPLICATIONS

This application claims priority from U.S. Provisional Patent Application Serial No. 60/283,406 filed Apr. 9, 2001 by inventors Paolo Ferrari and F. Carl Ambrogio entitled “Authentication and Certification System and Method”.

### BACKGROUND OF THE INVENTION

1. Field of the Invention

The present invention relates to item authentication and, more particularly, to a system and method for authenticating, certifying, delivering and tracking items.

2. Brief Description of Related Developments

There is a significant demand for autographed memorabilia items. Such memorabilia items include, but are not limited to, photos, sports items such as baseballs, sticks, various clothing, and other articles. Unfortunately, the monetary value associated with such items creates an incentive for counterfeiting. Such autographed memorabilia items are easy to counterfeit, as the signatures of athletes, celebrities and/or public figures can easily be duplicated and replicated on other memorabilia items. It is virtually impossible to verify whether the subsequent memorabilia item is genuine or not.

Previous systems are useful for establishing authenticity of an article, but they are limited insofar as they completely fail to certify the authenticity of an autographed item once title of ownership is transferred, i.e., the autographed article sold/bought is in fact the item the signatory had initially autographed. Other systems which are useful for authentication purposes of autographed memorabilia do not provide sufficient security within a controlled environment when dealing with counterfeiting with respect to transfer of ownership of autographed items and fraudulent articles. Security devices which have been used in attempts to prevent fraud include mediums such as holograms, stickers and a certificate of authenticity bearing the same visible serial number printed on such mediums. However, such mediums can be altered or replicated, opening the door to fraud.

It would be advantageous to provide a secure, fraud-free system for authenticating and certifying the ownership and authenticity of an autographed memorabilia item.

### SUMMARY OF THE INVENTION

The present invention is directed to a system for authentication of an item. In one embodiment, the system comprises a substantially invisible watermark secured to the item for uniquely identifying the item, wherein the watermark is nonremovable and includes a substantially invisible authentication code for identifying the item. A unique identification code is also associated with the item, wherein the identification code differs from the authentication code. A storage area includes owner identification information for linking the item to an owner, wherein the identification code is linked to the authentication code of the item and to the owner identification information. Entry of data which matches the linked owner identification information, the authentication code and the identification code in the storage area authenticates the ownership and certifies the authenticity of the item.

In one aspect, the present invention is directed to a method for authenticating an item. In one embodiment, the method includes the steps of securing a nonremovable substantially invisible watermark including a substantially invisible authentication code to the item for identifying the item. A unique identification code is generated for the item, wherein the identification code differs from the authentication code, and the authentication code and the identification code of the item are linked. Owner identification information of the item is linked to an owner by cross-referencing the owner identification information with the authentication code and the identification code. Authenticating includes entering data which matches the owner identification information, the authentication code and the identification code for authenticating the ownership and authenticity of the item.

In another aspect, the present invention is directed to a method for purchasing an autographed memorabilia item in a secure, fraud-free environment. In one embodiment, the method comprises selecting the autographed memorabilia item from available autographed memorabilia items in an inventory of a conduit trust, wherein each of the autographed memorabilia items includes a nonremovable substantially invisible watermark having a unique authentication code. Purchaser information including a purchaser identification code and a password is stored, and a unique randomly computer generated identification code is associated with the selected autographed memorabilia item, wherein the identification code differs from the authentication code.

The method further includes entering the selected autographed memorabilia item identification code into the database and linking the identification code to the purchaser identification code and password. The selected autographed memorabilia item is scanned to retrieve the is authentication code included in the watermark. The scanned authentication code included in the watermark is linked to the purchaser identification and password and to the autographed memorabilia item identification number for providing a fraud-free environment.

### BRIEF DESCRIPTION OF THE DRAWINGS

The foregoing aspects and other features of the present invention are explained in the following description, taken in connection with the accompanying drawings, wherein:

FIG. 1 is a block diagram illustrating an embodiment of the authentication and certification system of the present invention.

FIG. 2 is a block flow diagram illustrating an embodiment of the present invention in which an item is entered into the authentication system.

FIG. 3 is a block flow diagram illustrating an embodiment of the purchase process of the present invention.

FIG. 4 is a block flow diagram illustrating an embodiment of the authentication process of the present invention.

### DETAILED DESCRIPTION OF THE PREFERRED EMBODIMENT(s)

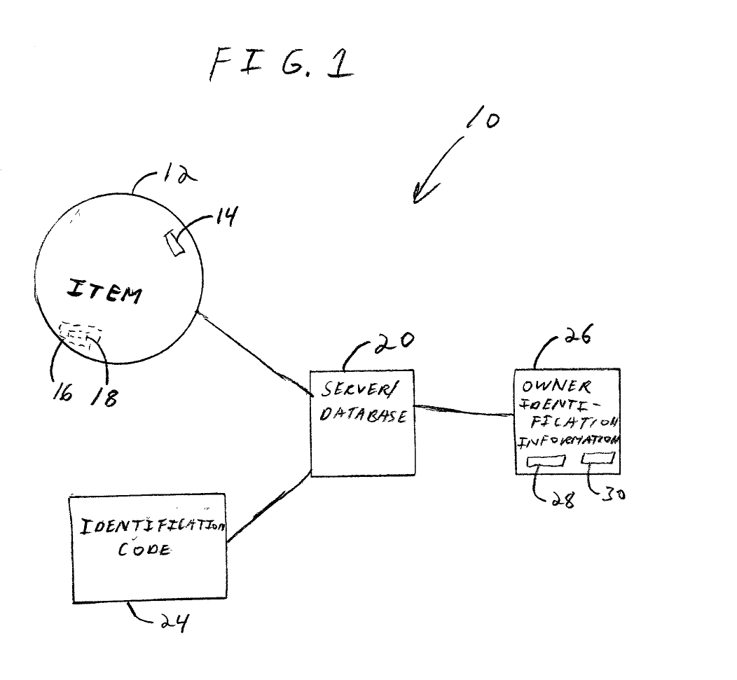

Referring to FIG. 1, there is shown a block diagram of an authentication and tracking system 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the authentication system 10 generally includes a substantially invisible watermark 16 for embedding in or placing on an item 12, such as an autographed memorabilia item 12 having a signature 14. The watermark 16 includes a substantially invisible authentication code 18, such as an alphanumeric code 18, for identifying a specific item 12. The authentication code 18 can be an alphanumeric code 18 randomly computer selected and encrypted to prevent duplication of the alphanumeric code 18. The authentication code 18 can be stored in a server/database 20 for tracking of the collectible item 12.

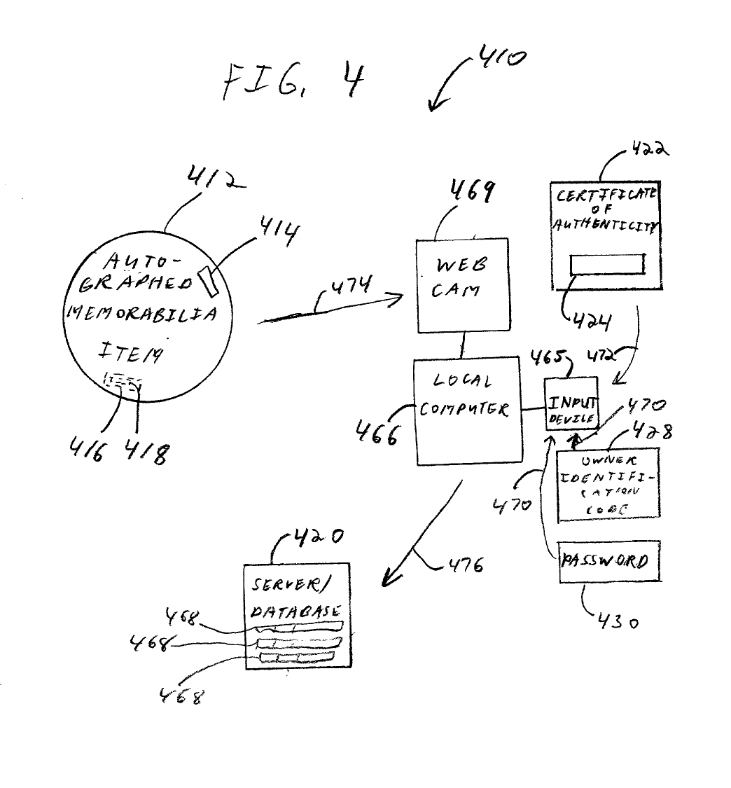

Referring to FIG. 1, a unique, computer generated identification code 24, such as a Sportagraph™ Identification Number (SPIN) is associated with the collectible item 12 for identifying the collectible item 12. The identification code 24 can be displayed on a certificate of authenticity 422 (See FIG. 4) which can be retained by an owner of the collectible item 12. The identification code 24 is stored in the database 20 and linked with the alphanumeric code 18 in the watermark 16. The identification code 24 differs from the alphanumeric code 18 to help prevent fraud caused by attempts to duplicate the alphanumeric code 18 in the watermark 16.

Continuing with FIG. 1, the database 20 also stores owner identification information 26 for linking the autographed memorabilia item 12 to the owner. The linking of the owner identification information 26, such as an owner identification code 28 and a password 30, with the identification code 24 of the certificate of authenticity 422 and the alphanumeric code 18 of the autographed memorabilia item 12 provides a secure fraud-free environment. The authentication and tracking system 10 creates a controlled and fraud-free environment, and provides a secure registration process to record subsequent transfers of ownership of the autographed memorabilia item 12, as will be described subsequently.

Continuing to refer to FIG. 1, the substantially invisible watermarks 16 are commercially available from companies, such as Digimarc™. The watermarks 16 are scannable by a digital or analog camera, such as a web cam. The watermark 16 is substantially invisible to the human eye and can not be removed from the autographed memorabilia item 12 without destroying the watermark and/or destroying or marring the autographed memorabilia item 12. Moreover, the unique alphanumeric code 18 embedded within the invisible watermark 16 can be decrypted only with software installed on the server 20.

FIG. 1 shows a method for a three level security system. In the first level, each consumer/purchaser is identified by the owner identification code 28 and the password 30. In the second level, each autographed memorabilia item 12 that each consumer/purchaser owns is registered with the identification code 24. The identification code 24 is displayed on the certificate of authenticity 422, or title of ownership 422. The user identification code 28 and password 30, as well as the identification code 24 of the certificate of authentication, can be information that consumer/purchasers will be requested to provide online. The identification code 24 in the Certificate of Authority, and the database 20, will be changed upon a transfer of ownership of the autographed memorabilia item 12.

In the third level, each autographed memorabilia item 12 includes the embedded invisible watermark 16 detectable by a digital or analog camera, such as a web cam. The autographed memorabilia article can be web scanned in order to lift the watermark and transport it to the database web server for certification. The autographed memorabilia item 12 will be deemed as an authentic and certifiable Sportagraph Conduit Trust item 12 when all of the above listed identifiers cross link in the database 20.

In the unlikely event a user is capable of lifting an image of the watermark 16 from the autographed memorabilia item 12 and placing it on another object, the second object will then have the same watermark 16 and encrypted alphanumeric code 18. Henceforth, there will be two watermarks with the same alphanumeric code 18 on different items linked to the associated identification code 24, the owner identification code 28 and the password 30 associated with the original autographed memorabilia item 12. The system, upon detection of the second similarly identified item, will immediately deactivate the second article from the database 20 when a user tries to certify the same items twice.

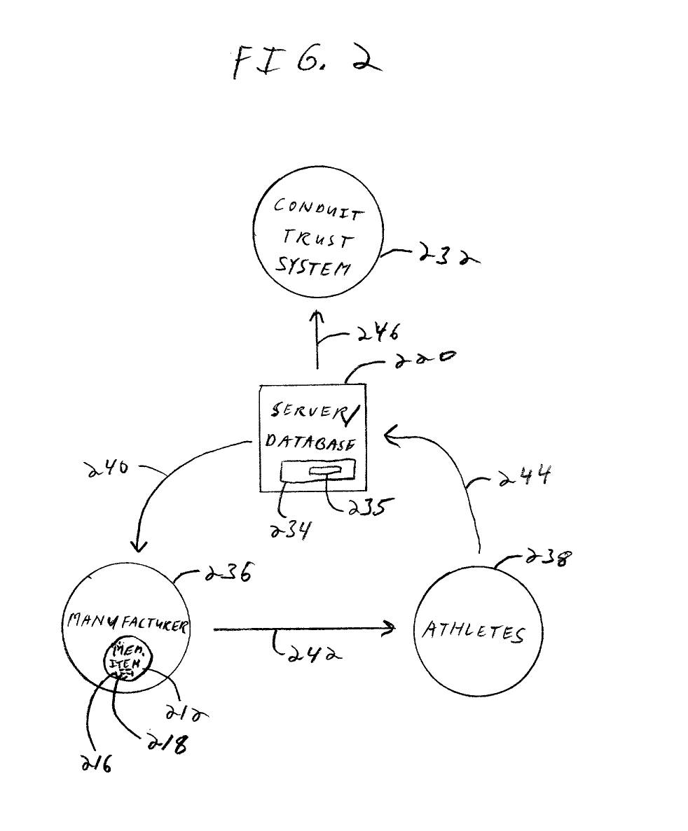

FIGS. 1 and 2 show an embodiment of the process 210 by which an autographed memorabilia item 212 has a watermark 216 applied, and a signature 14 applied by a signatory, and then shipped back to a manager of the system to enter an alphanumeric code 218 associated with the watermark 216 into the registry 220, or server/database 220, such as a server/database 220 operated by Sportagraph™. In a step 240, a digital file 234 containing individual and uniquely coded watermarks 216 is provided to the manufacturers 236 of the memorabilia items 212 by the registrar, such as Sportagraph™, which maintains the registration database and provides registration services. Each watermark 216 includes a unique encrypted alphanumeric code 235. The watermarks 216 and alphanumeric code 235 will be embedded in the memorabilia items 212 and recorded in the server/database 220. In a step 242, the watermarked memorabilia items 212 are shipped directly to signatories 238, such as athletes 238, celebrities 238 and public FIGS. 238, for the addition of autographs 14 by the signatories 238.

Referring to FIG. 2, in a step 244, the signatories 238 will ship all autographed memorabilia items 212 to the server/database 220. The substantially invisible alphanumeric code 218 on the watermark 216 embedded in each autographed memorabilia item 212 will in turn be scanned and matched with the alphanumeric code 235 stored in the server/database 220. A match is a confirmation of the autographed memorabilia item 212. In a step 246, each autographed memorabilia item 212 is encased in a clear plastic protective box and shipped to a warehouse operated by the conduit trust system 232.

Continuing to refer to FIG. 2, the conduit trust system 232 is a contractual trust arrangement for conveying autographed memorabilia articles 212 directly to the general public, and is responsible for the primary distribution of autographed memorabilia items 312. The trustees of the conduit trust system 232 will consist of representatives of the registrar of the authentication system 10, such as Sportagraph™, the athletes 238 and the sporting goods manufacturers 236. Through the conduit trust system 232, the athletes 238 and sporting goods manufacturers 236 will retain beneficial ownership of their autographed memorabilia items 212, which will be stored in secure, bonded facilities until sold to the public. The trustees of the conduit trust system 232 will hold only the legal power to effect the transfer, and will not have beneficial ownership to any memorabilia items 212 held in trust.

Continuing with FIG. 2, ownership of the autographed memorabilia item 212 will pass from the athletes 238 and sporting goods manufacturers 236 directly to the initial purchaser of the autographed memorabilia item, which eliminates an intermediate owner (like a store or a dealer). The reduced number of steps in the chain of title prevents fraud and improves the ability of the purchaser to demonstrate authenticity.

The trustees of the conduit trust system 232 will have the fiduciary duty under applicable law to manage the memorabilia items 212 held in trust in such a way as to benefit not themselves, but rather provide a service to the beneficiaries. If any trustee fails to do this, they will be required to account to the beneficiary and would be removed. During a primary transfer, an officer of the conduit trust system 232 signs the certificate of authenticity, or title of ownership, as agent for the signatory 238. Other features of the authentication system 10 can include contracts and/or agreements with athletes, celebrities and/or public figures to participate in the authentication system 10, and an insurance guarantee to cover fraudulent risk.

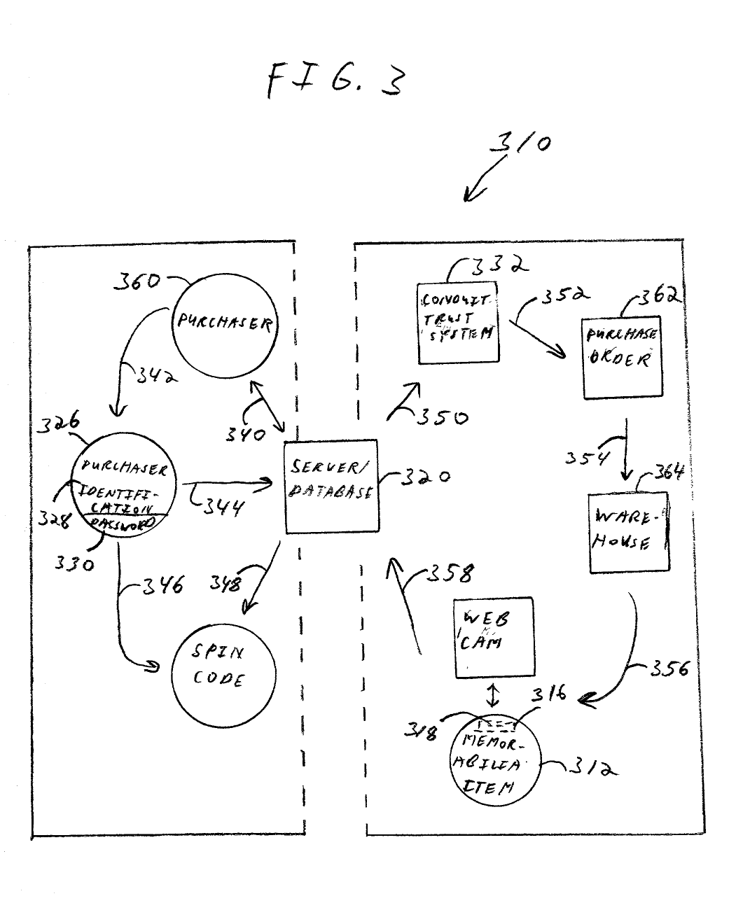

FIG. 3 shows an embodiment of a method to authenticate and certify each memorabilia item 312 sold by a conduit trust system 332 as part of the fulfillment process with the multilayered security system 310. In a step 340, the potential purchaser 360, such as a fan, browses through available products 312, such as autographed memorabilia items 312, in the conduit trust system 332. In a step 342, the potential purchaser 360 orders a autographed memorabilia item 312 for purchase. The potential purchaser 360 inputs all owner identification information 326 into a system database 320, and chooses an owner identification code 328 and a password 330.

Continuing to refer to FIG. 3, and in a step 344, the owner identification information 326 is stored in the server/database 320. In a step 346, a randomly computer generated identification code 324, such as a Sportagraph Identification Number (SPIN) code 324, will need to be associated with the purchased item. In a step 348, the server 320 will randomly select the SPIN 324 for the autographed memorabilia item 312 purchased and link it within the database 20 to the owner identification code 328 and the password 330. The SPIN 324 will be printed on a certificate of authenticity that will be sent with the autographed memorabilia item 312 to the purchaser 360.

As shown in FIG. 3, and in a step 350, the server 320 will send purchase order information 362 to the warehouse/fulfillment manager associated with the conduit trust system 332. In a step 352, the warehouse/fulfillment manager will print purchase order information 362, and, in a step 354, the ordered autographed memorabilia item 312 gets pulled from the warehouse 364. In a step 356, the watermark 316 on the autographed memorabilia item 312 is scanned, and the autographed memorabilia item 312 is placed with the certificate of authenticity in an appropriate shipping box with a preprinted shipping label, and shipped to the purchaser 360. In a step 358, the alphanumeric code 318, which was read from the watermark 316, is cross-linked to the owner identification code 328, the password 330 and to the SPIN 324 in the server 320.

Referring to FIG. 4, an embodiment of a method is shown by which an owner can identify an autographed memorabilia item 412 that they have purchased by connecting to the server/database 420. In a step 470, when prompted by the server/database 420, the owner will enter an owner identification code 428 and a password 430 into an input device 465 of a local computer 466 in communication with the server/database 420. This data 428, 430 will identify the owner and indicate the owner's autographed memorabilia items 412 by linking to any SPIN numbers 468 associated with the owner in the database 420. The server 420 will then request the SPIN number 424 associated with the autographed memorabilia item 412 the owner wishes to verify. In a step 472, the SPIN number 424 will be entered by the owner for verification purposes.

In a step 474, the owner will then be asked to scan the item in front of a web cam 469. In a step 476, through a point-to-point connection, the alphanumeric code 418 in the watermark 416 will be transmitted to the server 420 for identification purposes. The server 420 decrypts and identifies the alphanumeric code 418 within the watermark 416 and associates the alphanumeric code 418 to the owner identification code 428, the password 430 and SPIN number 424. The server 420 will send back a page to the user's local computer 466 confirming the authenticity of the autographed memorabilia item 412.

Lost or stolen autographed memorabilia items 412 will need to be reported immediately to the authentication and tracking system 410. These autographed memorabilia items 412 will be taken out of the tracking system 410 until the autographed memorabilia items 412 are either found or the owner informs the authentication and tracking system 410 that the autographed memorabilia items 412 cannot be found at which point the autographed memorabilia items 412 will be considered destroyed. As a service, stolen autographed memorabilia items 412 will be reported to the appropriate authorities.

In another embodiment, when an owner of the autographed memorabilia item 412 wishes to sell the autographed memorabilia item 412 to a third party, the autographed memorabilia item 412 will be exchanged directly or indirectly with the use of the authentication and tracking system 410, with the mutual consent from the seller and the buyer. The following steps complete the transaction between the buyer and seller. In the first step, both the buyer and the seller acknowledge to the manager of the authentication and tracking system 410 that they want this transaction to occur. In the second step, funds representing the purchase price of the memorabilia item 412 will be escrowed by the manager of the authentication and tracking system 410 or an authorized company. In a third step, prior to shipping the memorabilia item 412 to the buyer, the seller must scan the memorabilia item 412 to confirm authentication of the memorabilia item 412, including entering the SPIN number 424, the owner identification code 428 and the password 430. Upon completion of the transaction, it is the seller's responsibility to send the original certificate of authenticity/title of ownership 422 back to the manager of the authentication and tracking system 410.

Upon receiving the memorabilia item 412, the buyer must scan the memorabilia item 412 to confirm its authenticity. Once the authenticity of the memorabilia item 412 is established, the funds will be released to seller and a new certificate of authenticity/title of ownership 422 with a new SPIN number 424 will be shipped by the authentication and tracking system 410 to the buyer.

In summary, the invention relates to autographed memorabilia items 12, to a system to authenticate that the memorabilia item 12 is a genuine memorabilia item 12, or authenticate that the memorabilia item 12 is a signatory item signed by the athlete(s), celebrity(ies) or public figure(s) to which the memorabilia item 12 is related. The invention also relates to a tracking system and method inclusive of watermark technology that certifies within a fraud free environment that the memorabilia item 12 is in fact the original memorabilia item 12 when subsequently transferred to another owner.

One embodiment of the present system and method provides the autographed memorabilia item 12 with the invisible watermark 16 that incorporates an encrypted alphanumeric code 18 along with a certificate of authenticity 422 bearing a different unique identification code 24 that are both linked to an owner's identification code 28 and password 30. A fraudulent free environment is created because a link among each owner identification code 28, the password 30, the certificate of authority identification code 24 and the alphanumeric code 18 within the invisible watermark 16 is created within the database 20. This creates a unique record for each user, and a unique identification code 24 for each autographed memorabilia item that is unique to each user.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for authentication of an item, comprising:
a substantially invisible watermark secured to the item for uniquely identifying the item, wherein the watermark is nonremovable and includes a substantially invisible authentication code for identifying the item;
a unique identification code associated with the item, wherein the identification code differs from the authentication code;
a storage area including owner identification information for linking the item to an owner, wherein the identification code is linked to the authentication code of the item and to the owner identification information; and
wherein entry of data which matches the linked owner identification information, the authentication code and the identification code in the storage area authenticates the ownership and certifies the authenticity of the item.

2. A system of claim 1, wherein the item is a memorabilia item.

3. A system of claim 2, wherein the memorabilia item is an autographed memorabilia item.

4. A system of claim 1, wherein the authentication code is an alphanumeric code.

5. A system of claim 1, wherein the authentication code is encrypted.

6. A system of claim 1, wherein the identification code is an alphanumeric code.

7. A system of claim 1, wherein the identification code is included with a certificate of authenticity associated with the item.

8. A system of claim 1, further comprising a conduit trust system for improving an ability to demonstrate authenticity of the item and for primary distribution of the item, wherein the conduit trust system provides that an owner of the item retains beneficial ownership of the item while the item is entrusted to the conduit trust system.

9. A system of claim 1, wherein the substantially invisible watermark is readable by a scanner.

10. A system of claim 9, wherein the scanner is a camera.

11. A system of claim 10, wherein the camera is a web cam.

12. A system of claim 1, wherein the owner identification information includes an owner identification code and a password.

13. A system of claim 1, further comprising an insurance guarantee associated with the item to cover fraudulent risk.

14. A method for authentication of an item, comprising the steps of:
securing a nonremovable substantially invisible watermark including a substantially invisible authentication code to the item for identifying the item;
generating a unique identification code for the item, wherein the identification code differs from the authentication code;
linking the authentication code and the identification code of the item; and
linking owner identification information of the item to an owner by cross-referencing the owner identification information with the authentication code and the identification code; and
entering data which matches the owner identification information, the authentication code and the identification code for authenticating the ownership and authenticity of the item.

15. A method of claim 14, wherein the step of generating a substantially invisible watermark including a substantially invisible authentication code further includes encrypting the authentication code for preventing duplication of the authentication code.

16. A method of claim 14, wherein the item is a memorabilia item.

17. A method of claim 16, wherein the item is an autographed memorabilia item.

18. A method of claim 14, wherein the step of entering data further comprises the step of reading with a scanner the substantially invisible watermark including the authentication code of the item.

19. A method of claim 18, wherein in the step of reading the authentication code, the scanner is a camera.

20. A method of claim 19, wherein in the step of reading the authentication code, the scanner is a web cam.

21. A method of claim 14, wherein in the step of generating a unique identification code for the item, the identification code is included on a certificate of authenticity associated with the item.

22. A method of claim 14, wherein in the step of entering data which matches the owner identification information, the owner identification information includes an owner identification code and a password.

23. A method for authenticating an autographed memorabilia item for a transaction in a secure, fraud-free environment, comprising the steps of:
selecting the autographed memorabilia item from available autographed memorabilia items, wherein each of the autographed memorabilia items includes a nonremovable substantially invisible watermark having a unique authentication code;
storing purchaser information, including selecting a purchaser identification code and a password;
associating a unique, randomly computer-generated identification code with the selected autographed memorabilia item, wherein the identification code differs from the authentication code;
entering the selected autographed memorabilia item identification code and linking the identification code to the purchaser identification code and password;
scanning the selected autographed memorabilia item to retrieve the authentication code included in the watermark; and
linking the scanned authentication code included in the watermark to the purchaser identification and password and to the autographed memorabilia identification number in the database.

24. A method of claim 23, wherein in the step of entering the selected item identification code, the autographed memorabilia item identification code will be printed on a certificate of authenticity for shipping to the purchaser with the selected item.

25. The method of claim 23, wherein the step of scanning the selected autographed memorabilia item includes the step of scanning with a camera.

26. The method of claim 25, wherein in the step of scanning with a camera, the camera is a web cam.

27. The method of claim 23, wherein in the step of selecting, the authentication code is encrypted.
